(19) United States
(12) Patent Application Publication
(10) Pub. No.: US 2026/0012738 A1
(43) Pub. Date: Jan. 8, 2026

(54) EAR-WEARABLE ELECTRONIC DEVICE INCLUDING BAFFLE

(71) Applicant: Starkey Laboratories, Inc., Eden Prairie, MN (US)

(72) Inventors: Jundong Li, Eden Prairie, MN (US); Craig Feldsien, Prior Lake, MN (US); Masahiro Sunohara, Minneapolis, MN (US)

(21) Appl. No.: 19/258,292

(22) Filed: Jul. 2, 2025

Related U.S. Application Data
(60) Provisional application No. 63/667,962, filed on Jul. 5, 2024.

(51) Int. Cl. H04R 25/00

(52) U.S. Cl. CPC H04R 25/654; H04R 25/604; H04R 25/656

(57) ABSTRACT

Various embodiments of an ear-wearable electronic device are disclosed. The device includes a receiver disposed in a rear housing that is acoustically coupled to an acoustic port of a front housing of the device by a receiver path extending between the receiver and the acoustic port. The front and rear housings are connected to form an enclosure. The device further includes a microphone disposed in a spout portion of the front housing and acoustically coupled to the acoustic port by a microphone path that extends between a microphone inlet of the microphone and the acoustic port. A baffle disposed in the spout portion has a first end that extends at least to either a plane defined by the acoustic port or a mesh disposed over or at least partially within the acoustic port. The baffle at least partially defines a barrier that separates the receiver path and the microphone path.

### CROSS-REFERENCE TO RELATED APPLICATION

This application claims the benefit of U.S. Provisional Application No. 63/667,962, filed Jul. 5, 2024, the disclosure of which is incorporated by reference herein in its entirety.

### BACKGROUND

Ear-wearable electronic devices such as hearing devices are disposed in an ear of a wearer or inserted into an opening of an ear canal of the wearer and typically include a housing or shell with electronic components such as a receiver (i.e., speaker) disposed within the housing. The receiver is adapted to provide acoustic information in the form of acoustic waves to the wearer's ear canal from a controller either disposed within the housing of the hearing device or connected to the hearing device by a wired or wireless connection. This acoustic information can include music or speech from a recording or other source. For ear-wearable electronic devices such as hearing devices (e.g., hearing assistance devices), the acoustic information provided to the wearer can include ambient sounds such as speech from a person or persons that are speaking in proximity to the wearer. Such speech can be amplified so that the wearer can better hear the speaker.

Hearing assistance devices, such as hearing aids, can be used to assist wearers suffering hearing loss by amplifying sounds into one or both ear canals. Such devices typically include hearing assistance components such as a microphone for receiving ambient sound, an amplifier for amplifying the microphone signal in a manner that depends upon the frequency and amplitude of the microphone signal, a speaker or receiver for converting the amplified microphone signal to sound for the wearer, and a battery for powering the components.

### SUMMARY

In general, the present disclosure provides various embodiments of an ear-wearable electronic device and a system that includes such device. The device can include a baffle disposed in a spout portion of a front housing of an enclosure of the device that provides a barrier that separates a receiver path and a microphone path. The receiver path can be configured to acoustically couple a receiver or speaker that is disposed within a housing of the enclosure to an acoustic port disposed in a first end of the front housing of the enclosure such that acoustic waves produced by the receiver can propagate through the receiver path and beyond the acoustic port into an ear canal of a wearer of the device. Further, the microphone path can be configured to acoustically couple a microphone disposed in the spout portion to the acoustic port such that acoustic waves incident upon the acoustic port can propagate through the microphone path to a microphone inlet of the microphone, where the propagating acoustic waves can be detected by the microphone. The baffle can extend from the microphone to a plane defined by the acoustic port, to a mesh disposed over or at least partially within the acoustic port, or through the acoustic port and beyond the first end of the front housing. In one or more embodiments, the baffle can reduce elevated high frequency responses of the microphone caused by acoustic waves produced by the receiver that may be incident upon the microphone inlet as such waves propagate in the receiver path. Further, such reduction of high frequency responses can increase a dynamic range of the microphone.

In some aspects, the techniques described herein relate to an ear-wearable electronic device including: an enclosure including: a rear housing extending along a housing axis between a first end and a second end; and a front housing including a first end, a second end, and a spout portion extending along a spout axis between a first end and a second end, wherein the first end of the spout portion defines the first end of the front housing, wherein the second end of the front housing is connected to the first end of the rear housing and the first end of the front housing is configured to be disposed at least partially within an ear canal of a wearer; a receiver disposed in the rear housing, the receiver including a receiver housing and a receiver outlet disposed in the receiver housing; a receiver path that extends between the receiver and an acoustic port disposed in the first end of the front housing; a microphone disposed in the spout portion of the front housing, the microphone including a microphone housing and a microphone inlet disposed in an outer surface of the microphone housing; a microphone path that extends between the microphone inlet and the acoustic port; and a baffle disposed in the spout portion that extends between a first end and a second end, wherein the first end extends at least to either a plane defined by the acoustic port or a mesh disposed over or at least partially within the acoustic port, wherein the baffle at least partially defines a barrier that separates the receiver path and the microphone path.

In some aspects, the techniques described herein relate to an ear-wearable electronic device system including: an ear-wearable electronic device including: an enclosure including: a rear housing extending along a housing axis between a first end and a second end; and a front housing including a first end, a second end, and a spout portion extending along a spout axis between a first end and a second end, wherein the first end of the spout portion defines the first end of the front housing, wherein the second end of the front housing is connected to the first end of the rear housing and the first end of the front housing is configured to be disposed at least partially within an ear canal of a wearer; a receiver disposed in the rear housing, the receiver including a receiver housing and a receiver outlet disposed in the receiver housing; a receiver path that extends between the receiver and an acoustic port disposed in the first end of the spout portion of the front housing; a microphone disposed in the spout portion, the microphone including a microphone housing and a microphone inlet disposed in an outer surface of the microphone housing; a microphone path that extends between the microphone inlet and the acoustic port; and a baffle disposed in the spout portion that extends between a first end and a second end, wherein the first end extends at least to either a plane defined by the acoustic port or a mesh disposed over or at least partially within the acoustic port, wherein the baffle at least partially defines a barrier that separates the receiver path and the microphone path; a hearing module adapted to be disposed between an ear and a skull of the wearer, wherein the hearing module includes a module housing and electronic components disposed within the module housing; and a cable that connects the ear-wearable electronic device to the hearing module.

In some aspects, the techniques described herein relate to a method including: disposing a receiver in a rear housing of an enclosure adjacent a second end of the rear housing; disposing a microphone within a spout portion of a front housing, wherein the microphone includes a microphone housing and a microphone inlet disposed in an outer surface of the microphone housing; disposing a baffle in the spout portion; connecting a second end of the front housing to a first end of the rear housing to form the enclosure; and disposing a receiver path within the rear housing and the front housing, wherein the receiver path extends between the receiver and an acoustic port disposed in a first end of the front housing, wherein the receiver path acoustically couples the receiver to the acoustic port, wherein the baffle at least partially defines a barrier that separates the receiver path and a microphone path, and further wherein the microphone path extends between the microphone inlet and the acoustic port.

All headings provided herein are for the convenience of the reader and should not be used to limit the meaning of any text that follows the heading, unless so specified.

The terms “comprises” and variations thereof do not have a limiting meaning where these terms appear in the description and claims. Such terms will be understood to imply the inclusion of a stated step or element or group of steps or elements but not the exclusion of any other step or element or group of steps or elements. The term “consisting of” means “including,” and is limited to whatever follows the phrase “consisting of.” Thus, the phrase “consisting of” indicates that the listed elements are required or mandatory and that no other elements may be present. The term “consisting essentially of” means including any elements listed after the phrase and is limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

The words “preferred” and “preferably” refer to embodiments of the disclosure that may afford certain benefits, under certain circumstances; however, other embodiments may also be preferred, under the same or other circumstances. Furthermore, the recitation of one or more preferred embodiments does not imply that other embodiments are not useful and is not intended to exclude other embodiments from the scope of the disclosure.

In this application, terms such as “a,” “an,” and “the” are not intended to refer to only a singular entity but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

These and other aspects of the present disclosure will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

Throughout the specification, reference is made to the appended drawings, where like reference numerals designate like elements, and wherein:

FIG. 1 is a schematic perspective view of one embodiment of an ear-wearable electronic device system.

FIG. 2 is a schematic perspective view of one embodiment of an ear-wearable electronic device of the system of FIG. 1.

FIG. 3 is a schematic cross-section view of the ear-wearable electronic device of FIG. 2.

FIG. 4 is a schematic cross-section view of a portion of the ear-wearable electronic device of FIG. 2.

FIG. 5 is a schematic diagram of the ear-wearable electronic device system of FIG. 1.

FIG. 6 is a schematic cross-section view of a portion of the ear-wearable electronic device of FIG. 2 with an earbud connected to a first end of a front housing of the device.

FIG. 7 is a schematic cross-section view of a portion of another embodiment of an ear-wearable electronic device that can be utilized with the system of FIG. 1.

FIG. 8 is a schematic cross-section view of a portion of another embodiment of an ear-wearable electronic device that can be utilized with the system of FIG. 1.

FIG. 9 is a schematic cross-section view of one embodiment of a microphone assembly that can be utilized with the ear-wearable electronic device of FIG. 2.

FIG. 10 is a schematic diagram of one embodiment of a hearing module that can be utilized with the system of FIG. 1.

FIG. 11 is a flowchart of one embodiment of a method of manufacturing the ear-wearable electronic device of FIG. 2.

FIG. 12 is a graph of a frequency response function versus frequency for a currently-available design of an ear-wearable electronic device that does not include a baffle.

FIG. 13 is a graph of a frequency response function versus frequency for an embodiment of an ear-wearable electronic device that includes a baffle that extends to a spout mesh of the device.

FIG. 14 is a schematic cross-section view of a portion of another embodiment of an ear-wearable electronic device that can be utilized with the system of FIG. 1.

### DETAILED DESCRIPTION

In general, the present disclosure provides various embodiments of an ear-wearable electronic device and a system that includes such device. The device can include a baffle disposed in a spout portion of a front housing of an enclosure of the device that provides a barrier that separates a receiver path and a microphone path. The receiver path can be configured to acoustically couple a receiver or speaker that is disposed within a housing of the enclosure to an acoustic port disposed in a first end of the front housing of the enclosure such that acoustic waves produced by the receiver can propagate through the receiver path and beyond the acoustic port into an ear canal of a wearer of the device. Further, the microphone path can be configured to acoustically couple a microphone disposed in the spout portion to the acoustic port such that acoustic waves incident upon the acoustic port can propagate through the microphone path to a microphone inlet of the microphone, where the propagating acoustic waves can be detected by the microphone. The baffle can extend from the microphone to a plane defined by the acoustic port, to a mesh disposed over or at least partially within the acoustic port, or through the acoustic port and beyond the first end of the front housing. In one or more embodiments, the baffle can reduce elevated high frequency responses of the microphone caused by acoustic waves produced by the receiver that may be incident upon the microphone inlet as such waves propagate in the receiver path. Further, such reduction of high frequency responses can increase a dynamic range of the microphone.

In some currently-available devices, the microphone and receiver share the same compartment. This arrangement can place the microphone close to and along an acoustic path of the receiver. As a result, the microphone may sense a high sound pressure level signal from the receiver that can reduce a dynamic range of the microphone. Further reduction of the dynamic range of the microphone can be caused by wax mitigation devices such as mesh that are disposed between the microphone and an ear drum of a wearer as acoustic waves from the receiver can be redirected to the microphone.

One or more embodiments of ear-wearable electronic devices described herein can provide various advantages over these currently-available devices. For example, an ear-wearable electronic device can include a baffle disposed in a spout portion of a front housing of the device that can at least partially define a barrier that separates a receiver path that is acoustically coupled to a receiver and a microphone path that is acoustically coupled to the microphone. The baffle can extend from the microphone to at least a plane defined by an acoustic port of the device. In essence, such baffle can position a microphone inlet further downstream of the receiver path without increasing a size of the front housing of the device. One or more embodiments of such ear-wearable electronic devices can reduce elevated high frequency responses of the microphone, thereby increasing a dynamic range of the microphone.

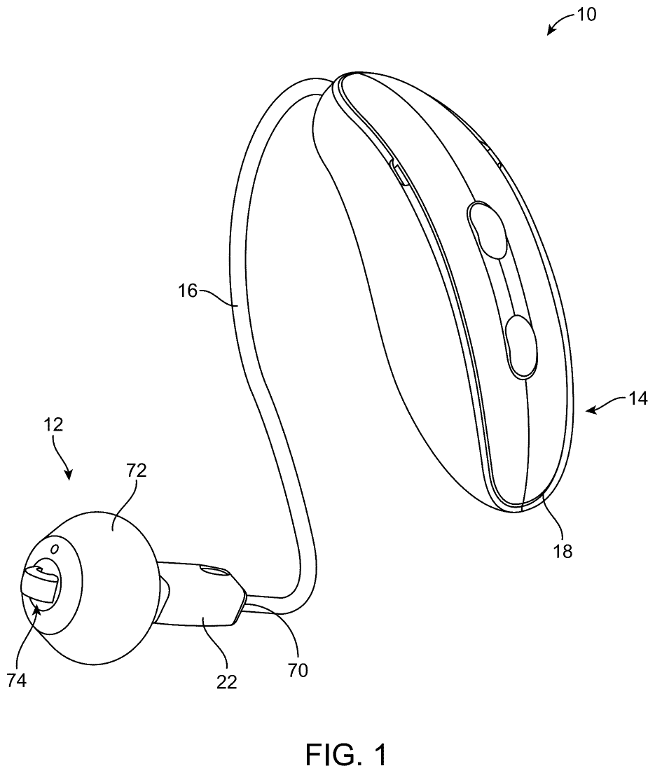

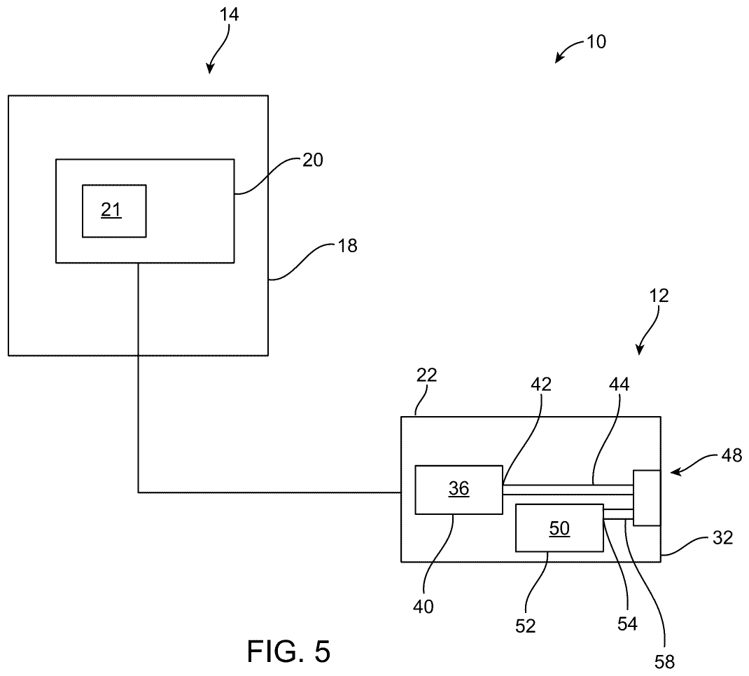

FIG. 1 is a schematic perspective view of one embodiment of an ear-wearable electronic device system 10. The system 10 includes an ear-wearable electronic device 12, a hearing module 14, and a cable 16 that connects the device to the hearing module. The hearing module 14 is adapted to be disposed between an ear and a skull of a wearer. As is further described herein, the hearing module 14 includes a module housing 18 and electronic components (electronic components 20 of FIG. 5) disposed within the module housing.

The ear-wearable electronic device 12 can include any suitable device that can provide acoustic energy to a wearer using any suitable technique, e.g., by directing sound into the ear of the wearer, bone conduction, implants, etc. In one or more embodiments, the device 12 can include over-the-ear or in-ear headphones, an earpiece, etc. Further, in one or more embodiments, the system 10 can include a hearing assistance device such as behind-the-ear (BTE), in-the-ear (ITE), in-the-canal (ITC), or completely-in-the-canal (CIC) type hearing devices. It is understood that behind-the-ear type hearing devices can reside substantially behind the ear or over the ear. Such devices can include receivers associated with an electronics portion of the behind-the-ear device, or receivers disposed in the ear canal of the user. Such devices are also known as receiver-in-the-canal (RIC) or receiver-in-the-ear (RITE) hearing devices.

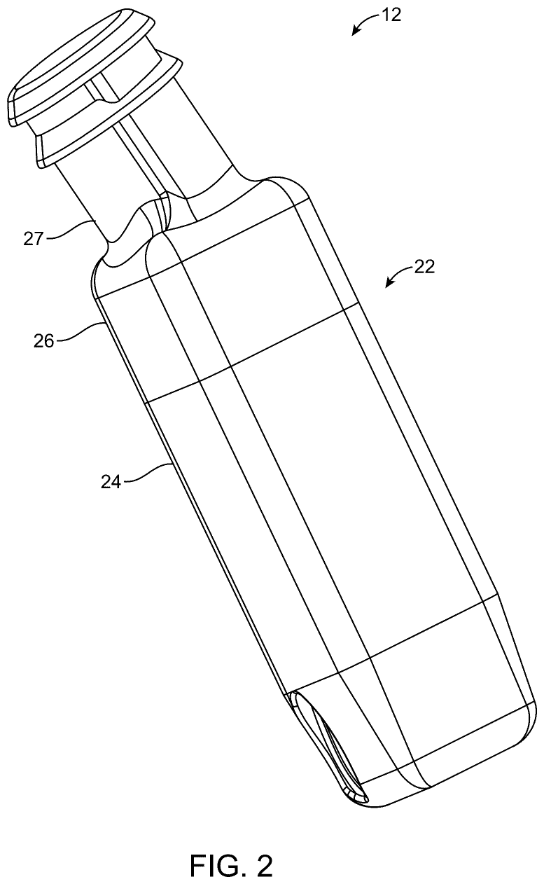

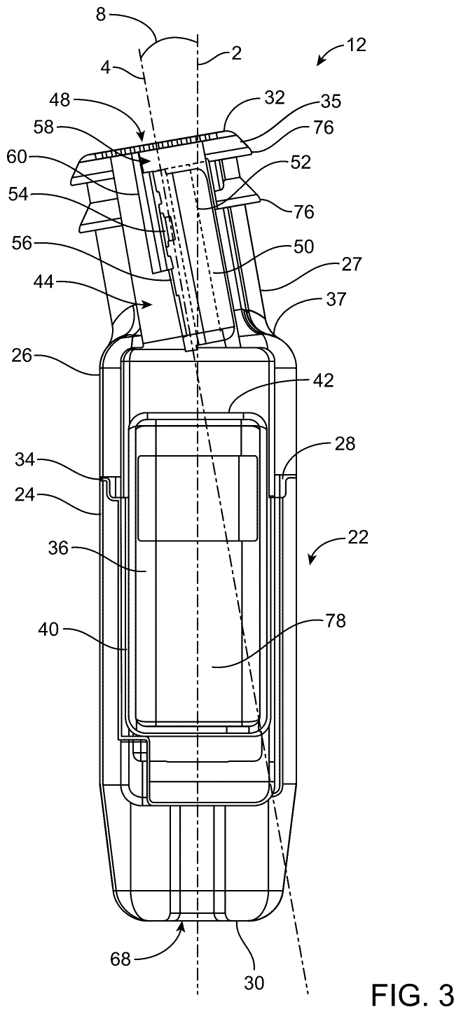

As shown in FIGS. 2-3, the device 12 includes an enclosure 22 having a rear housing 24 and a front housing 26 connected to the rear housing. The rear housing 24 extends along a housing axis 2 between a first end 28 and a second end 30. Further, the front housing 26 includes a first end 32, a second end 34, and a spout portion 27 that extends along a spout axis 4 between a first end 35 and a second end 37. The first end 35 of the spout portion 27 defines the first end 32 of the front housing 26. The second end 34 of the front housing 26 is connected to the first end 28 of the rear housing 24. The first end 32 of the front housing 26 is configured to be disposed at least partially within an ear canal of a wearer.

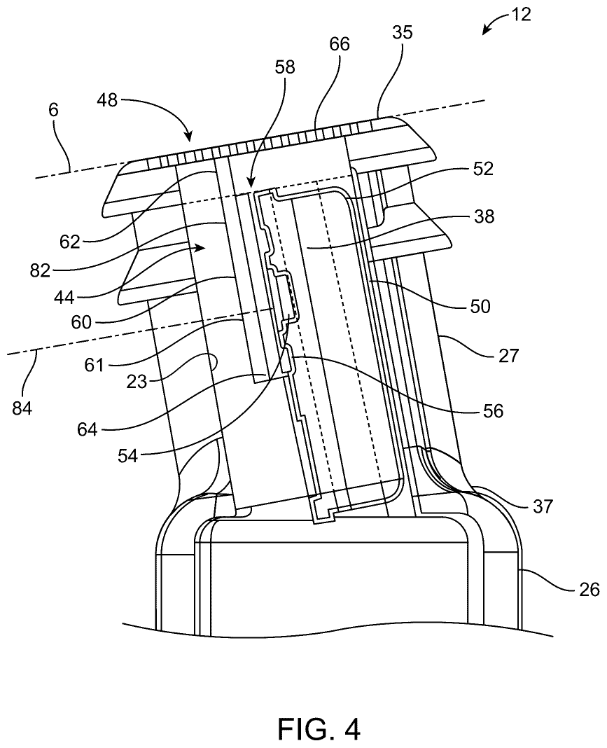

Any suitable electronic components can be disposed within the enclosure 22. As shown in FIGS. 3 and 5, the device 12 includes a receiver 36 disposed in the rear housing 24. The receiver 36 includes a receiver housing 40 and a receiver outlet 42 disposed in the receiver housing. A receiver path 44 extends between the receiver 36 and an acoustic port 48 disposed in the first end 32 of the front housing 26. The device 12 further includes a sensor 50 disposed in the spout portion 27 of the front housing 26. In one or more embodiments, the sensor 50 includes a microphone (referred to herein as microphone 50). The microphone 50 includes a microphone housing 52 and a microphone inlet 54 disposed in an outer surface 56 of the microphone housing. A microphone path 58 (FIG. 4) extends between the microphone inlet 54 and the acoustic port 48. Although depicted as including the receiver 36 and the microphone 50, in one or more embodiments, one or more additional components and/or circuitry can be disposed within the enclosure 22, e.g., at least one of a controller, amplifier, filter, GMR, switch, telecoil, sensor, or outward facing microphone as is further described herein.

The device 12 further includes a baffle 60 disposed in the spout portion 27 that extends between a first end 62 and a second end 64 (FIG. 4). In one or more embodiments, the first end 62 of the baffle 60 extends at least to either a plane 6 defined by the acoustic port 48 or a mesh 66 disposed over or at least partially within the acoustic port as is shown in FIG. 4. The baffle 60 at least partially defines a barrier 61 that separates the receiver path 44 and the microphone path 58.

The enclosure 22 can take any suitable shape and have any suitable dimensions. Further, the rear housing 24 of the enclosure 22, which extends along the housing axis 2 between the first end 28 and the second end 30, can take any suitable shape and have any suitable dimensions. The rear housing 24 can include any suitable material, e.g., at least one of an organic material or inorganic material. Suitable organic materials include one or more polymers such as thermoplastic polymers (e.g., thermoplastic polyurethanes, thermoplastic elastomers), thermoset polymers, photopolymers, etc. Further, the rear housing 24 can be manufactured utilizing any suitable technique, e.g., molding, injection molding, 3D printing, die-casting, metal injection molding, sintering, stamping, casting, etc.

The rear housing 24 can include a connector port 68 (FIG. 3) disposed in the second end 30 of the rear housing. The connector port 68 can be adapted to receive an end 70 of cable 16 (FIG. 1) that connects the hearing device 12 to the hearing module 14 such that the cable can connect the receiver 36, the microphone 50, and any other components or circuitry disposed within the enclosure 22 to one or more components or circuitry disposed within the hearing module 14.

Connected to the first end 28 of the rear housing 24 is the front housing 26. Such front housing 26 can take any suitable shape and have any suitable dimensions. In one or more embodiments, the front housing 26 can be configured to be disposed at least partially within the ear canal of the wearer.

Further, the front housing 26 can include any suitable material, e.g., at least one of an organic material or inorganic material. Suitable organic material can include any suitable polymer, e.g., thermoplastic polymers (e.g., thermoplastic polyurethanes, thermoplastic elastomers), thermoset polymers, photopolymers, etc. In one or more embodiments, the front housing 26 can include the same material as the rear housing 24. The front housing 26 can be manufactured utilizing any suitable technique, e.g., molding, injection molding, 3D printing, die-casting, metal injection molding, sintering, stamping, casting, etc.

As stated herein, the spout portion 27 of the front housing 26 extends along the spout axis 4 and the housing 24 extends along the housing axis 2. Any suitable angle 8 can be formed between the housing axis 2 and the spout axis 4. In one or more embodiments, the angle 8 can be about 0 degrees. In one or more embodiments, the angle 8 can be no greater than 70 degrees.

The rear housing 24 and the front housing 26 can be connected using any suitable technique to provide the enclosure 22. For example, the first end 28 of the rear housing 24 and the second end 34 of the front housing 26 can be connected by, e.g., bonding, adhering including adhesive bonding and adhesive tapes, welding, friction-fitting, snap fitting, etc. In one or more embodiments, the housing 24 and front housing 26 can be removably connected such that at least one of the rear housing or front housing can be replaced and/or elements or components disposed within the enclosure 22 can be serviced or replaced. Such removable connection between the rear housing 24 and the front housing 26 can provide a modular hearing device 12.

The mesh 66 of the front housing 26 can take any suitable shape and have any suitable dimensions. Further, the mesh 66 can include any suitable material. The mesh 66 can be disposed over the acoustic port 48 and connected to the first end 32 of the front housing 26 using any suitable technique. In one or more embodiments, the mesh 66 can be disposed at least partially within the acoustic port 48. In one or more embodiments, the mesh 66 can be disposed entirely within the acoustic port 48.

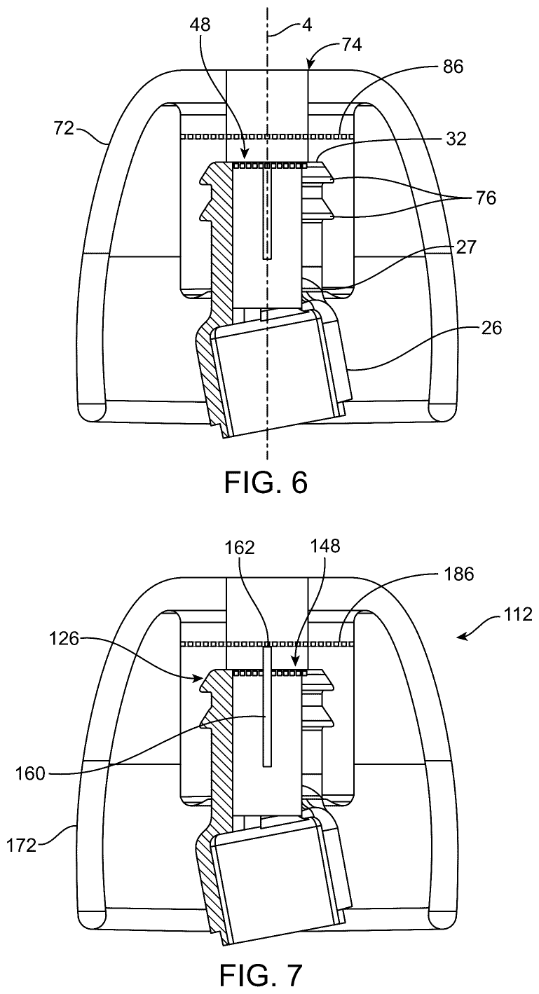

As shown in FIGS. 1 and 6, the hearing device 12 can include an earbud 72 connected to the first end 32 of the front housing 26. The earbud 72 can take any suitable shape and having any suitable dimensions. In one or more embodiments, the earbud 72 is integral with the front housing 26, i.e., formed as a single part with the spout portion during the manufacturing process. In one or more embodiments, the earbud 72 can be manufactured separately from the front housing 26 and connected to the front housing using any suitable technique. The earbud 72 includes an earbud acoustic port 74 that, in one or more embodiments, is aligned along the spout axis 4 with the acoustic port 48 in the first end 32 of the spout portion 27. The earbud acoustic port 74 can be acoustically coupled to the acoustic port 48 of the front housing 26. As used herein, the term “acoustically coupled” means fluidically coupled or that any barrier positioned between two or more elements or components that are acoustically coupled is generally acoustically transparent for frequencies of interest, where acoustically transparent means that the element or component attenuates sound at a sound pressure level of no greater than 6 dB.

The front housing 26 can include one or more flanges 76 that are adapted to retain the earbud 72. The front housing 26 can include any suitable number of flanges 76. Further, each flange 76 can take any suitable shape and have any suitable dimensions. In one or more embodiments, one or more of the flanges 76 can be a concentric flange.

The earbud 72 can also include an earbud mesh 86 disposed over or at least partially within the earbud acoustic port 74 as shown in FIG. 6, which is a schematic cross-section view of a portion of the device 12 with the microphone 50 removed for clarity. In one or more embodiments, the earbud mesh 86 can be disposed entirely within the earbud acoustic port 74. As used herein, the phrase “entirely within the earbud acoustic port” means that the earbud mesh 86 is disposed between the earbud acoustic port 74 and the acoustic port 48 of the front housing 26. Further, in one or more embodiments, the earbud mesh 86 can be disposed over the earbud acoustic port 74. The earbud mesh 86 can take any suitable shape and have any suitable dimensions. Further, the earbud mesh 86 can include any suitable material.

Disposed in any suitable position within the rear housing 24 is the receiver 36. In one or more embodiments, at least a portion of the receiver 36 can be disposed in the front housing 26. The receiver 36 can include any suitable receiver or receivers, e.g., a balanced armature speaker, MEMS speaker, dynamic driver speaker, piezo electric speaker, etc. The receiver 36 can be acoustically coupled to the acoustic port 48 by the receiver path 44. The receiver path 44 can take any suitable shape and have any suitable dimensions.

The receiver 36 includes the receiver housing 40 and the receiver outlet 42 disposed in any suitable portion of the receiver housing. The receiver 36 can further include one or more diaphragms 78 disposed within the receiver housing 40. The diaphragm 78 can be configured to vibrate in response to a signal from the controller 21 (FIG. 5) to provide acoustic waves representative of the signal. Such acoustic waves can propagate through the receiver outlet 42, the receiver path 44, and the acoustic port 48 to the ear canal of the ear of the wearer. In one or more embodiments, the receiver 36 can be disposed such that a major surface of the diaphragm 78 is configured to vibrate in a direction that is substantially orthogonal to a plane of a diaphragm 38 of the microphone 50. For example, as shown in FIG. 3, the diaphragm 78 of the receiver 36 is configured to vibrate in a direction substantially orthogonal to a plane of the figure. Further, the diaphragm 38 of the microphone 50 is configured to vibrate in a direction that is substantially in the plane of the figure. In other words, the diaphragm 78 of the receiver 36 and the diaphragm 38 of the microphone 50 vibrate in substantially orthogonal planes. Such orientation of the diaphragms 38, 78 may allow passive mechanical energy and acoustic energy to be less additive than if the diaphragms were vibrating along the same orientation.

Disposed in the spout portion 27 of the front housing 26 is the microphone 50. Although depicted as being disposed in the spout portion 27, the microphone 50 can be disposed in any suitable portion of the front housing 26, e.g., at least partially within the spout portion and one or more additional portions of the front housing. The microphone 50 can include any suitable microphone or microphones, e.g., a MEMS microphone, an electret condenser microphone, conjoined microphone sets, etc. In one or more embodiments, the microphone 50 can instead be any suitable sensor or sensors, e.g., at least one of a temperature, optical, or tactile sensor.

Although illustrated as having one microphone 50, the device 12 can have any suitable number of microphones. For example, the device 12 can include the microphone 50 and a second microphone disposed in the rear housing 24 adjacent the second end 30 of the rear housing. Such second microphone can be configured to sense ambient acoustic waves from the wearer's environment. See, e.g., one or more embodiments of hearing devices described in U.S. Patent Publication No. 2003/0300387 A1 to Higgins et al. and entitled HEARING DEVICE, or U.S. Patent Publication No. 2003/0300509 A1 to Higgins et al. and entitled HEARING DEVICE.

The microphone 50 can be disposed in any suitable position within the spout portion 27. In one or more embodiments, at least a portion of the microphone 50 can be disposed in the rear housing 24. Further, the microphone 50 can be oriented in any suitable position within the front housing 26 such that the inlet 54 of the microphone is acoustically coupled to the acoustic port 48 (FIG. 3).

The microphone 50 includes the microphone housing 52 and the microphone inlet 54 disposed in the outer surface 56 of the housing. The microphone 50 can be acoustically coupled to the acoustic port 48 using any suitable technique. In one or more embodiments, the microphone path 58 that extends between the microphone 50 and the acoustic port 48 can acoustically couple the microphone to the acoustic port using any suitable technique. The microphone path 58 can take any suitable shape and have any suitable dimensions.

The device 12 also includes the baffle 60 that is disposed in the spout portion 27 and that extends between the first end 62 and the second end 64 of the baffle. The baffle 60 at least partially defines the barrier 61 that separates the receiver path 44 and the microphone path 58.

The baffle 60 can take any suitable shape and have any suitable dimensions. For example, the baffle can have an L shaped cross-section in a plane substantially orthogonal to the outer surface 56 of the microphone housing 52. Further, the baffle 60 can have any suitable length as measured between its first end 62 and second end 64. The baffle 60 can also have any suitable width. In one or more embodiments, the baffle 60 has a width such that each side surface of the baffle that extends between the first end 62 and the second end 64 of the baffle is connected to an inner surface 23 of the spout portion 27 to completely isolate the receiver path 44 and the microphone path 58. The baffle 60 can include any suitable material, e.g., the same materials described herein regarding the front housing 26.

Further, the baffle 60 can be disposed in any suitable orientation or position relative to the microphone 50. For example, in one or more embodiments, the baffle 60 can be connected to the microphone housing 52 using any suitable technique. In one or more embodiments, a major surface 82 of the baffle 60 (FIG. 4) is substantially parallel to the outer surface 56 of the microphone housing 52. In such embodiments, a normal 84 of a plane defined by the microphone inlet 54 is substantially orthogonal to the major surface 82 of the baffle.

The first end 62 of the baffle 60 can be disposed in any suitable position relative to the plane 6 defined by the acoustic port 48. In one or more embodiments, the baffle 60 is configured such that the first end 62 extends at least to either the plane 6 defined by the acoustic port 48 or the mesh 66 that is disposed over or at least partially within the acoustic port. In one or more embodiments, the first end 62 of the baffle 60 extends to the mesh 66 as shown in FIG. 4. In such embodiments, the first end 62 can be connected to the mesh 66. In one or more embodiments, the baffle 60 can extend through this acoustic port 48 of the front housing 26. For example, FIG. 7 is a schematic cross-section view of a portion of another embodiment of an ear-wearable electronic device 112, where a microphone of the device is not shown for clarity. All design considerations and possibilities described herein regarding the device 12 of FIGS. 1-6 apply equally to the device 112 of FIG. 7 to the extent they do not conflict. As shown in FIG. 7, a baffle 160 extends through an acoustic port 148 of a front housing 126 to earbud mesh 186 of earbud 172. In one or more embodiments, a first end 162 of the baffle 160 can be connected to the earbud mesh 186 using any suitable technique.

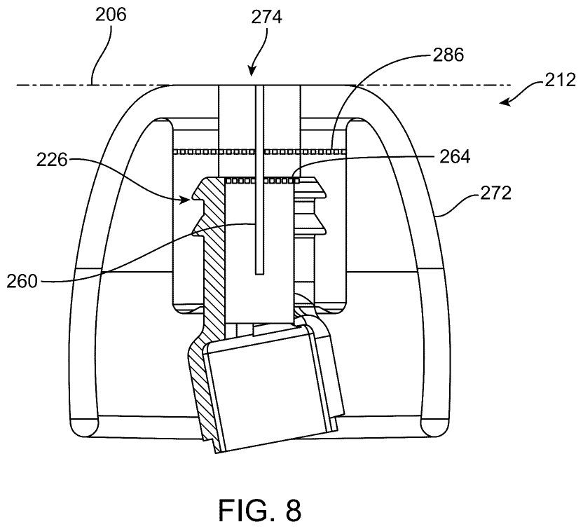

In one or more embodiments, the baffle 160 can extend through the earbud mesh 186 any suitable distance. For example, FIG. 8 is a schematic cross-section view of a portion of another embodiment of an ear-wearable electronic device 212. All design considerations and possibilities described herein regarding ear-wearable electronic device 12 of FIGS. 1-6 and ear-wearable electronic device 112 of FIG. 7 apply equally to ear-wearable electronic device 212 of FIG. 8 to the extent they do not conflict. As shown in FIG. 8, baffle 260 extends to a plane 206 defined by an earbud acoustic port 274 of an earbud 272. As a result, the baffle 260 extends through a mesh 264 of a front housing 226 of the device 212 and through an earbud mesh 286 of the earbud 272 to the plane 206 defined by the earbud acoustic port 274.

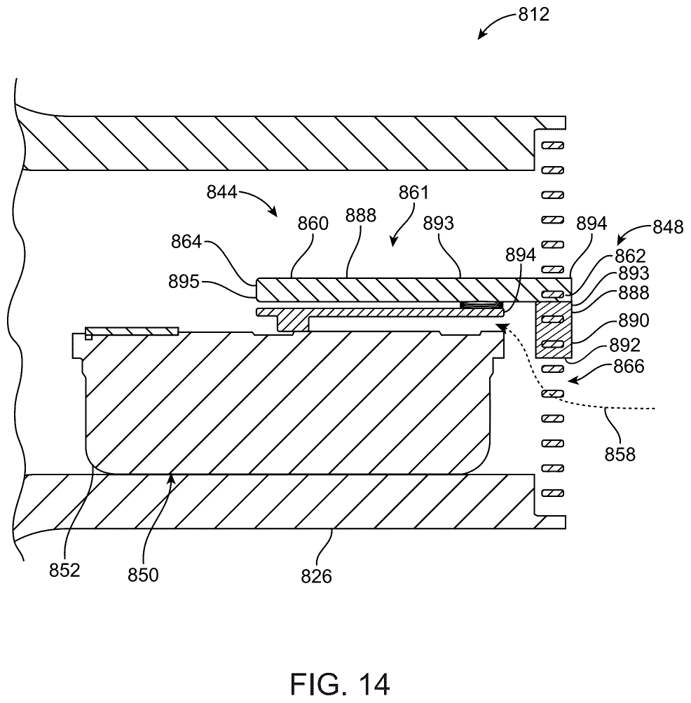

The various embodiments of baffles can be a single element or component or two or more portions that are connected together using any suitable technique to form the baffle. For example, FIG. 14 is a schematic cross-section view of a portion of another embodiment of an ear-wearable electronic device 812. All design considerations and possibilities described herein regarding ear-wearable electronic device 12 of FIGS. 1-6 apply equally to ear-wearable electronic device 812 of FIG. 14 to the extent they do not conflict. One difference between device 812 and device 12 is that baffle 860 includes a first portion 888 and a second portion 890 connected to the first portion to provide the baffle that extends between a first end 862 and a second end 864. The first end 862 extends to a mesh 866 disposed over or at least partially within an acoustic port 848 of front housing 826. The baffle 860 defines a barrier 861 that separates a receiver path 844 and a microphone path 858. The baffle 860 provides a tortuous microphone path 858 that can prevent ingress of debris from entering a microphone 850.

The first portion 888 of the baffle 860 extends between a first end 894 that defines the first end 862 of the baffle 860 and a second end 895 that defines the second end 864 of the baffle. Further, the second portion 890 of the baffle 860 extends between a first end 892 and a second end 893. The first portion 888 and the second portion 890 can be connected using any suitable technique to define the baffle 860. In one or more embodiments, the first end 894 of the first portion 888 can be connected to the second end 893 of the second portion 890 using any suitable technique, e.g., adhering, mechanically fastening, bonding, welding, etc. The first portion 888 can be connected to the second portion 890 prior to the second end 895 of the first portion being connected to the microphone 850, e.g., to a housing 852 of the microphone. In one or more embodiments, the first portion 888 can be connected to the microphone 850 and then connected to the second portion 890. Similarly, the second portion 890 of the baffle 860 can be connected to the mesh 866 prior to or after the second portion is connected to the first portion 888. In one or more embodiments, the first portion 888, the second portion 890, and the mesh 866 can be connected prior to connection of the first portion to the microphone 850. In one or more embodiments, the second portion 890 can be integral with the mesh 866, i.e., manufactured as a single piece or part, using suitable technique.

The second end 895 of the first portion 888 of the baffle 860 can be connected to the microphone 850 using any suitable technique. Further, the second portion 890 of the baffle 860 can be connected to the mesh 866 using any suitable technique.

Returning to FIGS. 1-6, the baffle 60 can be disposed at least partially within the spout portion 27 using any suitable technique. In one or more embodiments, one or more portions of the baffle 60 can be connected to the microphone 50. For example, as shown in FIG. 4, the second end 64 of the baffle 60 can be connected to the housing 52 of the microphone 50 using any suitable technique. In one or more embodiments, the baffle 60 can be connected to an inner surface 23 of the enclosure 22 in any suitable location. For example, the baffle 60 can be connected to the inner surface 23 of the enclosure 22 within the spout portion 27.

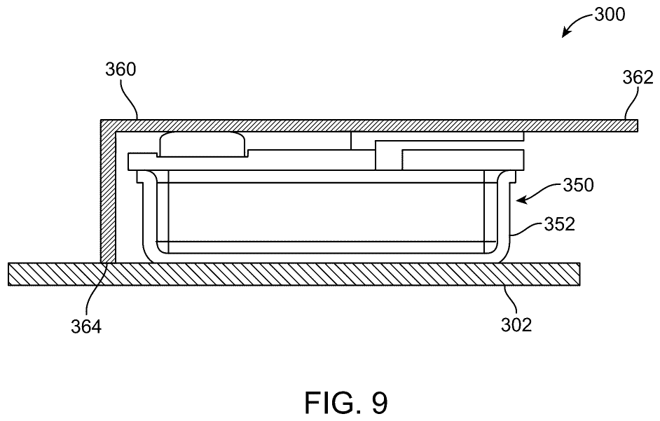

Any suitable technique can be utilized to dispose the microphone 50 and the baffle 60 within the enclosure 22. For example, FIG. 9 is a schematic cross-section view of one embodiment of a microphone assembly 300. The microphone assembly 300 includes a microphone 350 (e.g., microphone 50) disposed on a carrier 302 that is configured to be inserted into an enclosure, e.g., enclosure 22 of device 12 of FIGS. 1-6. The microphone assembly 300 further includes a baffle 360 having a first end 362 and a second end 364. In one or more embodiments, the second end 364 of the baffle 360 can be connected to the carrier 302 using any suitable technique. Further, one or more portions of the baffle 360 can also be connected to a housing 352 of the microphone 350 using any suitable technique.

Carrier 302 can include any suitable material. Further, the microphone 350 can be connected to the carrier 302 using any suitable technique, e.g., bonding, adhering including adhesive bonding and adhesive tapes, welding, friction-fitting, snap fitting, etc. The microphone assembly 300 can be disposed within an enclosure (e.g., enclosure 22 of FIGS. 1-5) using any suitable technique. In one or more embodiments, the carrier 302 can be connected to the inner surface 23 of the enclosure 22 using any suitable technique.

Returning to FIG. 1, the hearing module 14 can be adapted to be disposed between the ear and the skull of the wearer. The hearing module 14 includes the module housing 18 and electronic components 20 (FIG. 5) disposed within the module housing. The electronic components 20 of the hearing module 14 can include any suitable electronic component or circuitry, e.g., at least one of a controller, an integrated circuit, a power source, a microphone, or a speaker (i.e., receiver).

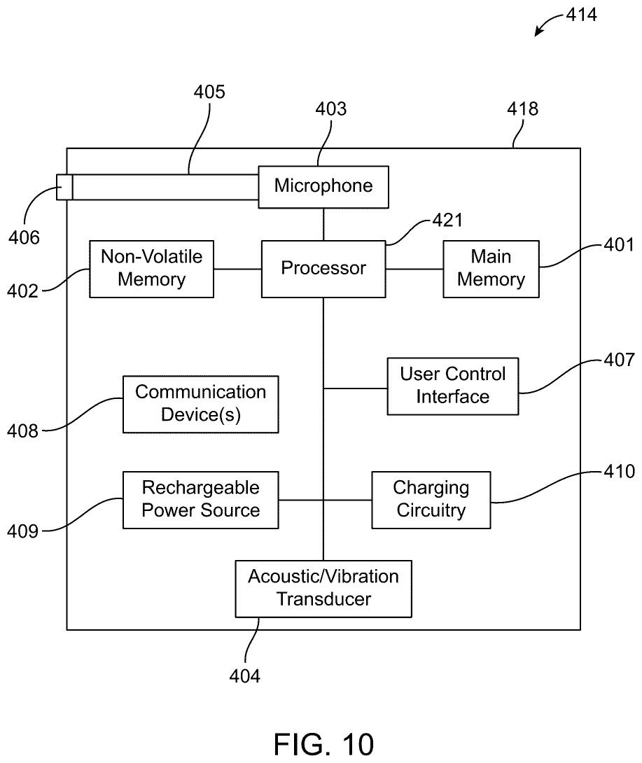

For example, FIG. 10 is a block diagram that illustrates one embodiment of a hearing module 414 in accordance with any of the embodiments disclosed herein. The module 414 can be utilized with any suitable ear-wearable electronic device system described herein, e.g., system 10 of FIGS. 1 and 5. The module 414 includes a module housing 418 configured to be worn in, on, or about an ear of a wearer. The module 414 shown in FIG. 10 can represent a single device configured for monaural or single-ear operation or one of a pair of modules for hearing device systems configured for binaural or dual-ear operation. In embodiments where an ear-wearable device system includes two or modules 414, each module can be connected to any suitable ear-wearable electronic device, e.g., device 12 of FIGS. 16. Various components are situated or supported within or on the module housing 418. The housing 418 can be configured for deployment on a wearer's ear (e.g., a behind-the-ear device housing).

The module 414 includes a processor or controller 421 operatively coupled to a main memory 401 and a non-volatile memory 402. The processor 421 can be implemented as one or more of a multi-core processor, a digital signal processor (DSP), a microprocessor, a programmable controller, a general-purpose computer, a special-purpose computer, a hardware controller, a software controller, a combined hardware and software device, such as a programmable logic controller, and a programmable logic device (e.g., FPGA, ASIC). The processor 421 can include or be operatively coupled to main memory 401, such as RAM (e.g., DRAM, SRAM). The processor 421 can include or be operatively coupled to non-volatile (persistent) memory 402, such as ROM, EPROM, EEPROM or flash memory. In one or more embodiments, the processor or controller 421 can be adapted to direct a noise canceling signal to the receiver 36 of the hearing device 12 of FIGS. 1-6 that is based upon a noise signal received from the microphone 50 using any suitable technique. The receiver 36 is adapted to direct a noise canceling acoustic wave into the ear canal of the wearer that is based upon this noise canceling signal from the controller 421. In one or more embodiments, the controller 421 is adapted to measure an occlusion value of the ear-wearable electronic device 12 in the ear canal of the wearer based upon an occlusion signal received from the microphone 50 in response to an acoustic wave directed into the ear canal by the receiver 36 and detected by the microphone 50 using any suitable technique, e.g., one or more of the techniques described in U.S. Patent Publication No. 2023/0173272 A1 to Griffin et al. and entitled HEARING DEVICE AND METHOD OF USING SAME.

The module 414 includes an audio processing facility operably coupled to, or incorporating, the processor 421. The audio processing facility includes audio signal processing circuitry (e.g., analog front-end, analog-to-digital converter, digital-to-analog converter, DSP, and various analog and digital filters), a microphone arrangement 403, and an optional acoustic/vibration transducer 404 (e.g., loudspeaker, receiver, bone conduction transducer, motor actuator). The microphone arrangement 403 can include one or more discrete microphones or a microphone array(s) (e.g., configured for microphone array beamforming). Each of the microphones of the microphone arrangement 403 can be situated at different locations of the module housing 418. It is understood that the term microphone used herein can refer to a single microphone or multiple microphones unless specified otherwise. The microphone 403 is operatively coupled to the processor 421 and is configured to direct a microphone signal to the processor, which in turn directs a receiver signal to the transducer 404 that is based at least in part on the microphone signal.

At least one of the microphones 403 may be configured as a reference microphone that produces a reference signal in response to external sound outside an ear canal of a user. Generally, at least one of the reference microphones 403 (also referred to as an externally facing microphone) is acoustically coupled to ambient air outside the module housing 418 via an acoustic pathway or acoustic path 405 and a microphone port 406. The microphone port 406 allows air to pass between two parts of the module housing 418 or may be formed within one part of the housing.

The module 414 can also include a user control interface 407 operatively coupled to the processor 421. The user control interface 407 is configured to receive an input from the wearer of the module 414. The input from the wearer can be any type of user input, such as a touch input, a gesture input, or a voice input. The user control interface 407 may be configured to receive an input from the wearer of the module 414.

The module 414 can include one or more communication devices 408. For example, the one or more communication devices 408 can include one or more radios coupled to one or more antenna arrangements that conform to an IEEE 802.13 (e.g., Wi-Fi®) or Bluetooth® (e.g., BLE, Bluetooth® 4.2, 5.0, 5.1, 5.2 or later) specification, for example. In addition, or alternatively, the module 414 can include a near-field magnetic induction (NFMI) sensor (e.g., an NFMI transceiver coupled to a magnetic antenna) for effecting short-range communications (e.g., ear-to-ear communications, ear-to-kiosk communications). The communications device 408 may also include wired communications, e.g., universal serial bus (USB) and the like.

The module 414 also includes a power source 409, which can be a conventional battery, a rechargeable battery (e.g., a lithium-ion battery), or a power source including a supercapacitor. In the embodiment shown in FIG. 10, the module 414 includes a rechargeable power source 409 that is operably coupled to power management circuitry for supplying power to various components of the module. The rechargeable power source 409 is coupled to charging circuity 410. The charging circuitry 410 is, for example, electrically coupled to charging contacts on the module housing 418 that are configured to electrically couple to corresponding charging contacts of a charging unit when the module is placed in the charging unit.

The module 414 can further include any other suitable electronic elements or components. Although not shown, the module 414 can include one or more inertial measurement units (IMUs) disposed within the module housing 418.

Returning to FIGS. 1-6, the electronic components 20 of the hearing module 14 can be electrically connected to the hearing device 12 by the cable 16. Further, in one or more embodiments, the electronic components 20 can be connected to the hearing device 12 by a wireless connection using any suitable wireless technique.

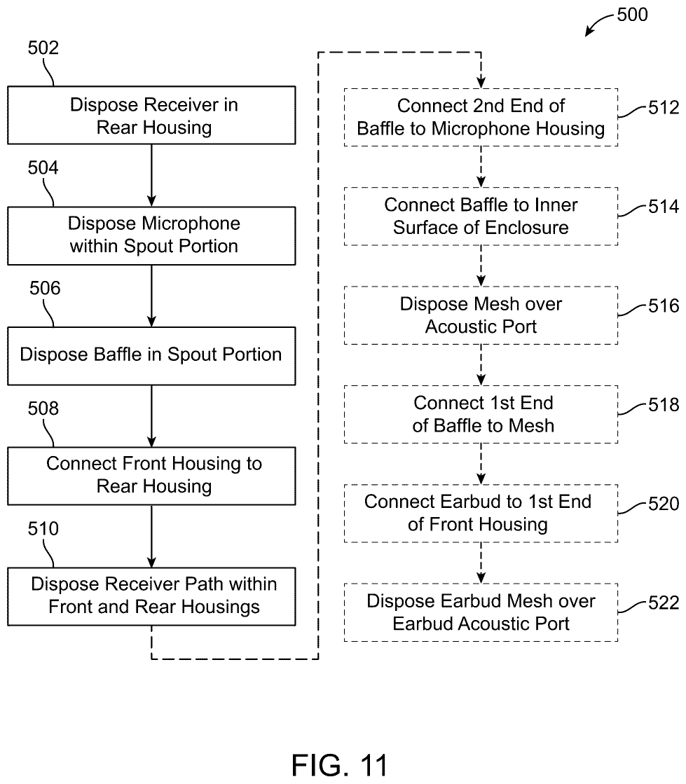

The various embodiments of ear wearable electronic devices described herein can be manufactured using any suitable technique. For example, FIG. 11 is a flowchart of one embodiment of a technique 500 for manufacturing the ear wearable electronic device 12. Although described regarding ear-wearable electronic device 12 of FIGS. 1-6, the technique 500 can be utilized to manufacture any suitable ear-wearable electronic device.

At 502, the receiver 36 can be disposed in the rear housing 24 of the enclosure 22 adjacent the second end 30 of the rear housing using any suitable technique. The microphone 50 can be disposed within the spout portion 27 of the front housing 26 using any suitable technique at 504. Further, at 506, the baffle 60 can be disposed in the spout portion 27 using any suitable technique. The baffle 60 at least partially defines the barrier 61 that separates the receiver path 44 and the microphone path 58. Further, the microphone path 58 extends between the microphone inlet 54 and the acoustic port 48. The second end 34 of the front housing 26 can be connected to the first end 28 of the rear housing 24 at 508 using any suitable technique to form the enclosure 22. At 510, the receiver path 44 can be disposed within the rear housing 24 and the front housing 26, where the receiver path extends between the receiver 36 and the acoustic port 48 disposed in the first end 32 of the front housing. The receiver path 44 acoustically couples the receiver 36 to the acoustic port 48 using any suitable technique.

At 512, the second end 64 of the baffle 60 can optionally be connected to the microphone housing 52 using any suitable technique. In one or more embodiments, the baffle 60 can optionally be connected to the inner surface 23 of the enclosure 22 at 514 using any suitable technique.

At 516, the mesh 66 can optionally be disposed over or at least partially within the acoustic port 48 using any suitable technique. In one or more embodiments as described herein, the first end 62 of the baffle 60 can extend to the mesh 66. In one or more embodiments, the first end 62 of the baffle 60 can be connected to the mesh 66 at 518 using any suitable technique.

At 520, the earbud 72 can optionally be connected to the first end 32 of the front housing 26 using any suitable technique, where the earbud includes earbud acoustic port 74 that is acoustically coupled to the acoustic port 48 of the front housing using any suitable technique. In embodiments that include the earbud 72, the baffle 60 can extend through the acoustic port 48 to the earbud acoustic port 74.

Further, at 522, the earbud mesh 86 can optionally be disposed over or at least partially within the earbud acoustic port 74 using any suitable technique. In such embodiments, the baffle 60 can extend to the earbud mesh 86 as shown in FIG. 7, where the baffle 160 extends through the acoustic port 148 of the front housing 126 to the earbud mesh 186 of the earbud 172.

### EXAMPLE

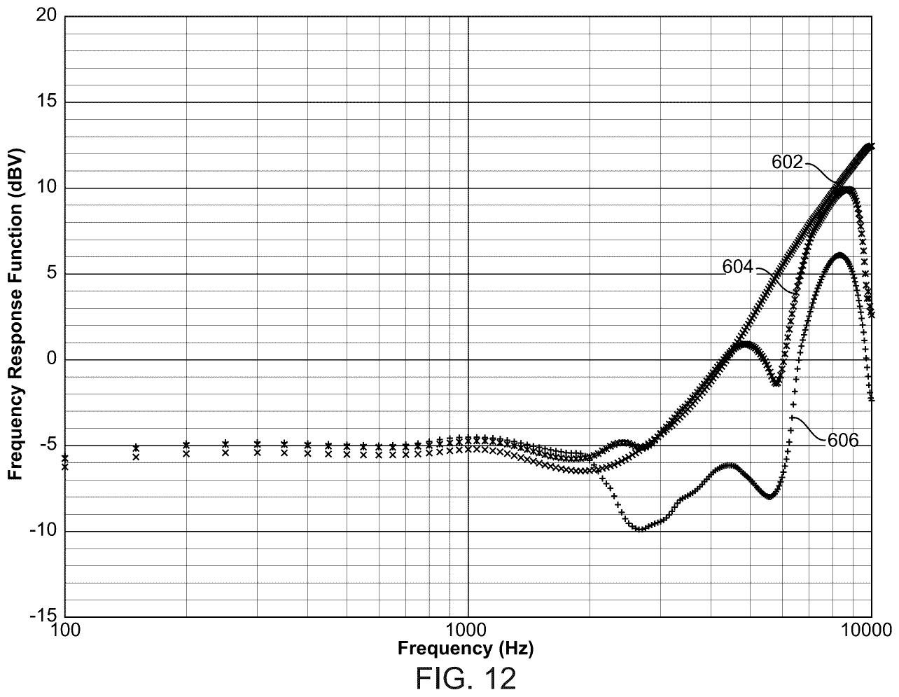

A test configuration that included a currently-available ear-wearable electronic device and an IEC 60318-4 (711) occluded ear simulator (OES) coupler (available from GRAS Sound & Vibration, Denmark), acoustically coupled to the device was utilized to measure a frequency response function (dBV) of a microphone of the coupler and a microphone of the device versus frequency (Hz) in response to acoustic waves provided by a receiver of the device. The currently-available device did not include a baffle (e.g., baffle 60 of device 12). FIG. 12 is a graph of the frequency response function versus frequency of the acoustic waves provided by the receiver of the device. The receiver of the device was driven at 0.1 V (curve 602), 0.5 V (curve 604), and 0.9 V (curve 606). The frequency response function of the y-axis was calculated as being equal to a microphone signal of the microphone of the ear-wearable device in response to the receiver output (dBV) minus a microphone signal of the microphone of the coupler in response to the receiver output (dBV). The frequency response function between the device microphone and the coupler microphone can replicate the relationship between the device microphone and the ear drum of the wearer.

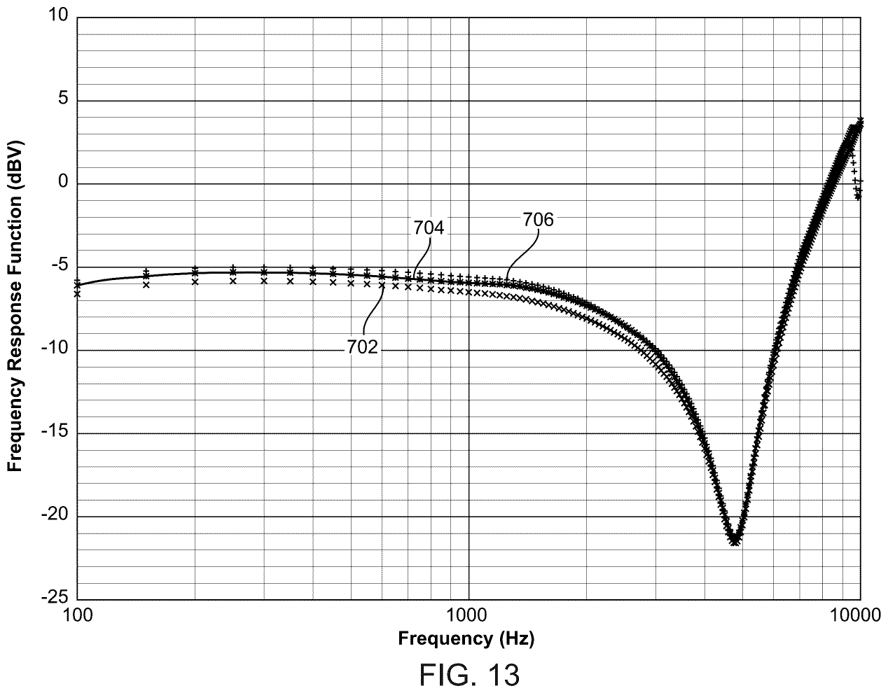

The currently-available ear-wearable electronic device was then replaced with an exemplary ear-wearable electronic device that included a baffle that extended from a microphone of the device to a mesh disposed at least partially within an acoustic port of the device (e.g., device 12 of FIGS. 1-5). FIG. 13 is a graph of the frequency response function versus frequency for the device having this baffle. A receiver of the device was driven at 0.1 V (curve 702), 0.5 V (curve 704), and 0.9 V (curve 706). A frequency response function that corresponds to the y-axis was calculated as being equal to a microphone signal of the microphone of the device in response to the receiver output (dBV) minus a microphone signal of the microphone of the coupler (dBV).

To estimate the sound pressure at the ear drum, the device microphone should not be saturated or clipping. In FIG. 12, curve 604, which is representative of driving the receiver of the device at 0.5V, differs from curve 602, which is representative of driving the receiver at 0.1V. This indicates that the device microphone is saturated when the receiver is driven at 0.5V. When driving the receiver of the non-baffle device at 0.9V (curve 606), the saturation condition is even more pronounced. As shown in FIG. 13, the frequency response function of the device that included the baffle is more consistent between drive voltages. This indicates that the device microphone is not saturated except in the very high frequency range (e.g., about 9k Hz) when the receiver was driven at 0.9V (curve 706). The absence of saturation of the microphone of the device that included the baffle can indicate that the baffle reduced elevated high frequency responses of the microphone that may be caused by high pressure level signals from the receiver that are incident upon the microphone inlet from within the device.

Embodiments of the disclosure are defined in the claims; however, herein there is provided a non-exhaustive listing of non-limiting examples. Any one or more of the features of these examples may be combined with any one or more features of another example, embodiment, or aspect described herein.

Example Ex1. An ear-wearable electronic device that includes an enclosure having a rear housing extending along a housing axis between a first end and a second end, and a front housing that includes a first end, a second end, and a spout portion extending along a spout axis between a first end and a second end, where the first end of the spout portion defines the first end of the front housing. The second end of the front housing is connected to the first end of the housing, and the first end of the front housing is configured to be disposed at least partially within an ear canal of a wearer. The device further includes a receiver disposed in the rear housing that includes a receiver housing and a receiver outlet disposed in the receiver housing, a receiver path that extends between the receiver and an acoustic port disposed in the first end of the front housing, and a microphone disposed in the spout portion. The microphone includes a microphone housing and a microphone inlet disposed in an outer surface of the microphone housing. The device further includes a microphone path that extends between the microphone inlet and the acoustic port, and a baffle disposed in the spout portion that extends between a first end and a second end. The first end of the baffle extends at least to either a plane defined by the acoustic port or a mesh disposed over or at least partially within the acoustic port. Further, the baffle at least partially defines a barrier that separates the receiver path and the microphone path.

Example Ex2. The device of Ex1, further including the mesh disposed over or at least partially within the acoustic port, where the first end of the baffle extends to the mesh.

Example Ex3. The device of Ex2, where the first end of the baffle is connected to the mesh.

Example Ex4. The device of any one of Ex1-Ex3, further including an earbud connected to the first end of the front housing, where the earbud includes an earbud acoustic port that is acoustically coupled to the acoustic port of the front housing.

Example Ex5. The device of Ex4, where the baffle extends through the acoustic port to the earbud acoustic port.

Example Ex6. The device of any one of Ex4-Ex5, further including earbud mesh disposed over or at least partially within the earbud acoustic port.

Example Ex7. The device of Ex6, where the baffle extends to the earbud mesh.

Example Ex8. The device of any one of Ex1-Ex7, where the baffle is connected to the microphone housing.

Example Ex9. The device of any one of Ex1-Ex8, where a major surface of the baffle is substantially parallel to the outer surface of the microphone housing, where a normal to a plane defined by the microphone inlet is substantially orthogonal to the major surface of the baffle.

Example Ex10. The device of any one of Ex1-Ex9, where the baffle is connected to an inner surface of the enclosure.

Example Ex11. The device of any one of Ex1-Ex10, where the microphone is disposed on a carrier that is configured to be inserted into the enclosure.

Example Ex12. The device of Ex11, where the baffle is connected to the carrier. Example Ex13. The device of any one of Ex1-Ex12, where the receiver is disposed such that a major surface of a diaphragm of the receiver is configured to vibrate in a direction substantially orthogonal to a plane of a diaphragm of the microphone.

Example Ex14. The device of any one of Ex1-Ex13, where the baffle includes an L shaped cross-section in a plane substantially orthogonal to the outer surface of the microphone

Example Ex15. An ear-wearable electronic device system including an ear-wearable electronic device. The ear-wearable electronic device includes an enclosure having a rear housing extending along a housing axis between a first end and a second end, and a front housing that includes a first end, a second end, and a spout portion extending along a spout axis between a first end and a second end, where the first end of the spout portion defines the first end of the front housing. The second end of the front housing is connected to the first end of the rear housing and the first end of the front housing is configured to be disposed at least partially within an ear canal of a wearer. The device further includes a receiver disposed in the rear housing that includes a receiver housing and a receiver outlet disposed in the receiver housing, a receiver path that extends between the receiver and an acoustic port disposed in the first end of the front housing, and a microphone disposed in the spout portion. The microphone includes a microphone housing and a microphone inlet disposed in an outer surface of the microphone housing. The device further includes a microphone path that extends between the microphone inlet and the acoustic port, and a baffle disposed in the spout portion that extends between a first end and a second end, where the first end extends at least to either a plane defined by the acoustic port or a mesh disposed over or at least partially within the acoustic port. The baffle at least partially defines a barrier that separates the receiver path and the microphone path. The ear-wearable electronic device further includes a hearing module adapted to be disposed between an ear and a skull of the wearer, where the hearing module includes a module housing and electronic components disposed within the module housing; and a cable that connects the ear-wearable electronic device to the hearing module.

Example Ex16. The system of Ex15, where the electronic components of the hearing module include a controller that is operatively connected to the ear-wearable electronic device.

Example Ex17. The system of Ex16, where the controller is adapted to direct a noise canceling signal to the receiver that is based upon a noise signal received from the microphone, and where the receiver is adapted to direct a noise canceling acoustic wave into the ear canal of the wearer that is based upon the noise canceling signal from the controller.

Example Ex18. The system of any one of Ex16-Ex17, where the controller is adapted to measure an occlusion value of the ear-wearable electronic device in the ear canal of the wearer based upon an occlusion signal received from the microphone in response to an acoustic wave directed into the ear canal by the receiver and detected by the microphone.

Example Ex19. The system of any one of Ex16-Ex18, further including the mesh disposed over or at least partially within the acoustic port, where the first end of the baffle extends to the mesh.

Example Ex20. The system of Ex19, where the first end of the baffle is connected to the mesh.

Example Ex21. The system of any one of Ex16-Ex20, further including an earbud connected to the first end of the front housing, wherein the earbud includes an earbud acoustic port that is acoustically coupled to the acoustic port of the front housing.

Example Ex22. The system of Ex21, where the baffle extends through the acoustic port to the earbud acoustic port.

Example Ex23. The system of any one of Ex21-Ex22, further including earbud mesh disposed over or at least partially within the earbud acoustic port.

Example Ex24. The system of Ex23, where the baffle extends to the earbud mesh.

Example Ex25. The system of any one of Ex16-Ex24, where the baffle is connected to the microphone housing.

Example Ex26. The system of any one of Ex16-Ex25, where a major surface of the baffle is substantially parallel to the outer surface of the microphone housing, and where a normal to a plane defined by the microphone inlet is substantially orthogonal to the major surface of the baffle.

Example Ex27. The system of any one of Ex16-Ex26, where the baffle is connected to an inner surface of the enclosure.

Example Ex28. The system of any one of Ex16-Ex27, where the microphone is disposed on a carrier that is configured to be inserted into the enclosure.

Example Ex29. The system of Ex28, where the baffle is connected to the carrier. Example Ex30. The system of any one of Ex16-Ex29, where the receiver is disposed such that a major surface of a diaphragm of the receiver is configured to vibrate in a direction substantially orthogonal to a plane of a diaphragm of the microphone.

Example Ex31. The system of any one of Ex16-Ex30, where the baffle includes an L shaped cross-section in a plane substantially orthogonal to the outer surface of the microphone

Example Ex32. A method including disposing a receiver in a rear housing of an enclosure adjacent a second end of the rear housing; disposing a microphone within a spout portion of a front housing, where the microphone includes a microphone housing and a microphone inlet disposed in an outer surface of the microphone housing; and disposing a baffle in the spout portion. The method further includes connecting a second end of the front housing to a first end of the rear housing to form the enclosure, and disposing a receiver path within the rear housing and the front housing, where the receiver path extends between the receiver and an acoustic port disposed in a first end of the front housing, where the receiver path acoustically couples the receiver to the acoustic port, where the baffle at least partially defines a barrier that separates the receiver path and a microphone path, and where the microphone path extends between the microphone inlet and the acoustic port.

Example Ex33. The method of Ex32, further including disposing a mesh over or at least partially within the acoustic port, where the first end of the baffle extends to the mesh.

Example Ex34. The method of Ex33, further including connecting the first end of the baffle to the mesh.

Example Ex35. The method of any one of Ex32-Ex34, further including connecting an earbud to the first end of the front housing, where the earbud includes an earbud acoustic port that is acoustically coupled to the acoustic port of the front housing.

Example Ex36. The method of Ex35, where the baffle extends through the acoustic port to the earbud acoustic port.

Example Ex37. The method of any one of Ex35-Ex36, further including disposing an earbud mesh over or at least partially within the earbud acoustic port.

Example Ex38. The method of Ex37, where the baffle extends to the earbud mesh. Example Ex39. The method of any one of Ex32-Ex38, further including connecting the second end of the baffle to the microphone housing.

Example Ex40. The method of any one of Ex32-Ex39, further including connecting the baffle to an inner surface of the enclosure.

Example Ex41. The method of any one of Ex32-40, further including disposing the microphone on a carrier, and inserting the carrier and microphone into the enclosure.

Example Ex42. The method of Ex41, further including connecting the baffle to the carrier.

All references and publications cited herein are expressly incorporated herein by reference in their entirety into this disclosure, except to the extent they may directly contradict this disclosure. Illustrative embodiments of this disclosure are discussed and reference has been made to possible variations within the scope of this disclosure. These and other variations and modifications in the disclosure will be apparent to those skilled in the art without departing from the scope of the disclosure, and it should be understood that this disclosure is not limited to the illustrative embodiments set forth herein. Accordingly, the disclosure is to be limited only by the claims provided below.

What is claimed is:

1. An ear-wearable electronic device comprising:
an enclosure comprising:
a rear housing extending along a housing axis between a first end and a second end; and
a front housing comprising a first end, a second end, and a spout portion extending along a spout axis between a first end and a second end, wherein the first end of the spout portion defines the first end of the front housing, wherein the second end of the front housing is connected to the first end of the rear housing and the first end of the front housing is configured to be disposed at least partially within an ear canal of a wearer;
a receiver disposed in the rear housing, the receiver comprising a receiver housing and a receiver outlet disposed in the receiver housing;
a receiver path that extends between the receiver and an acoustic port disposed in the first end of the front housing;
a microphone disposed in the spout portion of the front housing, the microphone comprising a microphone housing and a microphone inlet disposed in an outer surface of the microphone housing;
a microphone path that extends between the microphone inlet and the acoustic port; and
a baffle disposed in the spout portion that extends between a first end and a second end, wherein the first end extends at least to either a plane defined by the acoustic port or a mesh disposed over or at least partially within the acoustic port, wherein the baffle at least partially defines a barrier that separates the receiver path and the microphone path.

2. The device of claim 1, further comprising the mesh disposed over or at least partially within the acoustic port, wherein the first end of the baffle extends to the mesh.

3. The device of claim 2, wherein the first end of the baffle is connected to the mesh.

4. The device of claim 1, further comprising an earbud connected to the first end of the front housing, wherein the earbud comprises an earbud acoustic port that is acoustically coupled to the acoustic port of the front housing, wherein the baffle extends through the acoustic port to the earbud acoustic port.

5. The device of claim 4, further comprising earbud mesh disposed over or at least partially within the earbud acoustic port, wherein the baffle extends to the earbud mesh.

6. The device of claim 1, wherein the baffle is connected to the microphone housing.

7. The device of claim 1, wherein a major surface of the baffle is substantially parallel to the outer surface of the microphone housing, wherein a normal to a plane defined by the microphone inlet is substantially orthogonal to the major surface of the baffle.

8. The device of claim 1, wherein the receiver is disposed such that a major surface of a diaphragm of the receiver is configured to vibrate in a direction substantially orthogonal to a plane of a diaphragm of the microphone.

9. An ear-wearable electronic device system comprising:
an ear-wearable electronic device comprising:
an enclosure comprising:
a rear housing extending along a housing axis between a first end and a second end; and
a front housing comprising a first end, a second end, and a spout portion extending along a spout axis between a first end and a second end, wherein the first end of the spout portion defines the first end of the front housing, wherein the second end of the front housing is connected to the first end of the rear housing and the first end of the front housing is configured to be disposed at least partially within an ear canal of a wearer;
a receiver disposed in the rear housing, the receiver comprising a receiver housing and a receiver outlet disposed in the receiver housing;
a receiver path that extends between the receiver and an acoustic port disposed in the first end of the spout portion of the front housing;
a microphone disposed in the spout portion, the microphone comprising a microphone housing and a microphone inlet disposed in an outer surface of the microphone housing;
a microphone path that extends between the microphone inlet and the acoustic port; and
a baffle disposed in the spout portion that extends between a first end and a second end, wherein the first end extends at least to either a plane defined by the acoustic port or a mesh disposed over or at least partially within the acoustic port, wherein the baffle at least partially defines a barrier that separates the receiver path and the microphone path;
a hearing module adapted to be disposed between an ear and a skull of the wearer, wherein the hearing module comprises a module housing and electronic components disposed within the module housing; and
a cable that connects the ear-wearable electronic device to the hearing module.

10. The system of claim 9, further comprising the mesh disposed over or at least partially within the acoustic port, wherein the first end of the baffle extends to the mesh.

11. The system of claim 10, wherein the first end of the baffle is connected to the mesh.

12. The system of claim 9, further comprising an earbud connected to the first end of the front housing, wherein the earbud comprises an earbud acoustic port that is acoustically coupled to the acoustic port of the front housing, wherein the baffle extends through the acoustic port to the earbud acoustic port.

13. The system of claim 12, further comprising earbud mesh disposed over or at least partially within the earbud acoustic port, wherein the baffle extends to the earbud mesh.

14. The system of claim 12, wherein the baffle is connected to the microphone housing.

15. The system of claim 9, wherein the baffle comprises an L shaped cross-section in a plane substantially orthogonal to the outer surface of the microphone housing.

16. A method comprising:
disposing a receiver in a rear housing of an enclosure adjacent a second end of the rear housing;
disposing a microphone within a spout portion of a front housing, wherein the microphone comprises a microphone housing and a microphone inlet disposed in an outer surface of the microphone housing;
disposing a baffle in the spout portion;
connecting a second end of the front housing to a first end of the rear housing to form the enclosure; and
disposing a receiver path within the rear housing and the front housing, wherein the receiver path extends between the receiver and an acoustic port disposed in a first end of the front housing, wherein the receiver path acoustically couples the receiver to the acoustic port, wherein the baffle at least partially defines a barrier that separates the receiver path and a microphone path, and further wherein the microphone path extends between the microphone inlet and the acoustic port.

17. The method of claim 16, further comprising disposing a mesh over or at least partially within the acoustic port, wherein the first end of the baffle extends to the mesh.

18. The method of claim 17, further comprising connecting the first end of the baffle to the mesh.

19. The method of claim 16, further comprising connecting an earbud to the first end of the front housing, wherein the earbud comprises an earbud acoustic port that is acoustically coupled to the acoustic port of the front housing, wherein the baffle extends through the acoustic port to the earbud acoustic port.

20. The method of claim 19, further comprising disposing an earbud mesh over or at least partially within the earbud acoustic port, wherein the baffle extends to the earbud mesh.
